(19) United States
(12) Patent Application Publication
(10) Pub. No.: US 2003/0067578 A1
(43) Pub. Date: Apr. 10, 2003

(54) Fluorescence-enhanced reflective LCD

(75) Inventor: Anthony Cyril Lowe, Braishfield (GB)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/225,619

(22) Filed: Aug. 22, 2002

(30) Foreign Application Priority Data
Oct. 6, 2001 (GB) 0124068.8

(51) Int. Cl. C09K 19/60

(52) U.S. Cl. 349/164

(57) ABSTRACT

A reflective liquid crystal display has a quarter wave plate and a film of fluorescent material located between a compartment containing a guest-host liquid crystal material and a reflector. In the dark state, light which has been reflected from the reflector excites the fluorescent layer. The light emitted by the fluorescent layer is absorbed by the guest-dye molecules in the liquid crystal and so does not exit from the compartment to the viewer. In the light state, light which has been reflected from the reflector excites the fluorescent layer. The light emitted by the fluorescent layer passes through the guest dye molecules in the liquid crystal display and exits from the guest dye molecules in the liquid crystal display and exits from the compartment to the viewer, thus enhancing the reflectivity of the display in the light state without degrading the dark state, thus enhancing the contrast ratio.

### TECHNICAL FIELD

The present invention relates to liquid crystal displays and particularly to reflective light crystal displays.

### BACKGROUND OF THE INVENTION

Reflective liquid crystal displays require a minimum reflectivity of 60% for satisfactory visual performance to be achieved. Higher reflectivity than this is advantageous, but a reflectivity of even 60% is difficult to achieve.

Prior art solutions to increase the reflectivity include the use of holographic reflectors to concentrate much of the reflected light within a narrow solid angle. However, when the display is viewed outside this optimum cone, the reflectance of the display is much lower. This restricts the useful viewing angle of the display.

Displays having higher reflectivity without compromising the viewing angle are desired, especially in the field of displays for pervasive computing devices. Up to 50% of the internet traffic presently carried by personal computers is expected to shift to such devices in three to four years. There will therefore be increased demand for high performance hand held devices.

So it would be desirable to provide a liquid crystal display having a higher reflectivity but without compromising the viewing angle.

### SUMMARY OF THE INVENTION

Accordingly, the present invention provides a guest-host liquid crystal display comprising: at least one compartment containing a guest-host liquid crystal; a reflecting layer located adjacent to a surface of the at least one compartment; a quarter wave plate located between the reflecting layer and the at least one compartment; and characterised in that the liquid crystal display further comprises: a film containing an aligned layer of fluorescent material located between the at least one compartment and the quarter wave plate.

The addition of a fluorescent layer improves the reflectivity of the display and hence the contrast ratio.

### BRIEF DESCRIPTION OF THE DRAWINGS

Embodiments of the invention will now be described, by way of example only, with reference to the accompanying drawings, in which:

FIG. 1 is a diagram of a guest-host liquid crystal display in a “dark” state including an aligned layer of fluorescent material according to the present invention; and

FIG. 2 is a diagram of the guest-host liquid crystal display of FIG. 1 in a “light” state.

### DETAILED DESCRIPTION OF THE PREFERRED EMBODIMENT

This invention describes a means by which the reflectivity of the bright state of a reflective display can be increased without significantly degrading the reflectivity of the dark state. It is optimally applied to single cell displays, as described in GB patent application 2345979, but is also applicable to other types of liquid crystal displays. The combination results in an extremely high reflectivity display having extremely low power consumption.

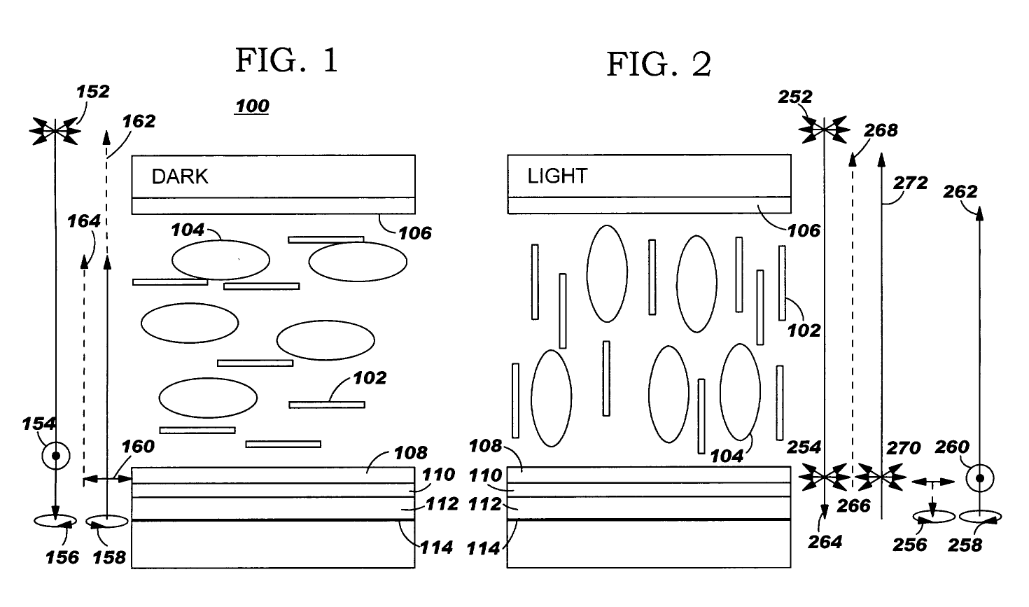

Referring to FIG. 1, a guest-host liquid crystal display 100 comprises one or more compartments containing a liquid crystal (host), 102, into which is dissolved a dye (guest), 104. The dye molecules absorb light polarised parallel to the transition dipole of the dye. Thus the display can be switched between two states; a dark state (shown in FIG. 1) in which the transition dipoles of the dye 104 are substantially parallel to the plane of the display 100 and a light state (shown in FIG. 2) in which the dipoles are substantially perpendicular to the plane of the display 100.

In FIG. 1, unpolarised light enters 152 the liquid crystal display 100. The liquid crystal 102 is in its dark state, so light polarised parallel to the plane of the page is absorbed. The light arriving 154 at the transparent rear electrode 108 is substantially plane polarised perpendicular to the plane of the page. The liquid crystal display also comprises a transparent front electrode 106 which will not be described further as the transparent front electrode and transparent rear electrode are well known in the art. Behind the electrode 108 is located a film 110 containing an aligned layer of fluorescent material. It is known to persons skilled in the art how to produce such an aligned layer of fluorescent material and this will not be described further. The film 110 is oriented so that only light polarised in the plane of the page will excite fluorescence. The light incident on the film 110 is substantially plane polarised perpendicular to the plane of the page and thus does not cause fluorescence of the film to occur.

The light propagates through a quarter wave plate, 112, and emerges at the far side of the quarter wave plate 112 as circularly polarised light 156. The light is then reflected by a reflector, 114, which results in the handedness of the polarisation being reversed 158. The light emerges 160 from the front face of the quarter wave plate 112 polarised in the plane of the page. The emerging light passes through the liquid crystal (102/104) where because it is polarised in the plane parallel to the page, it is largely absorbed, with a small proportion 162 emerging from the front surface of the display 100. The emerging light also causes fluorescence of the film 110 to occur. Because the polarisation of the light emitted by the film 110 is parallel to the polarisation of the light striking the film and exciting the fluorescence, the light emitted by the film 110 is also polarised in the plane parallel to the page and the light emitted by the film 110 is absorbed 164 by the guest dye molecules 104. Two components 162, 164 of the exiting light have been described. In the dark state of the liquid crystal 102, the component 162 derived from the light incident on the liquid crystal display 100 has been attenuated to a large degree and the component 164 derived from the fluorescent film layer 110 has been attenuated to the same degree. Since the intensity of the component 164 of the light was lower than the intensity of the component 162 of the light the reflected light is effectively completely attenuated by the liquid crystal 102. Thus the darkness of the dark state of the liquid crystal display is substantially unaltered.

Referring to FIG. 2, unpolarised light enters 252 the liquid crystal display. The liquid crystal 102 is in its light state, so light of all polarisations arrives 254 at the transparent rear electrode 108.

The light incident on the film 110 causes some fluorescence to occur, with the light emitted by the film 110 being polarised in the plane parallel to the page. This light propagates through the quarter wave plate 112 and emerges at the far side of the quarter wave plate 112 as circularly polarised light 256. The emitted light is then reflected by the reflector 114, which results in the handedness of the polarisation being reversed 258. The light emerges 260 from the front face of the quarter wave plate 112 substantially plane polarised perpendicular to the plane of the page. The light passes through the film 110 without causing further fluorescence as it is not polarised in the plane of the page. The light passes through the liquid crystal (102/104) largely unattenuated as the guest dye molecules 104 are in their light state with a large proportion 262 of the light emerging from the front surface of the display 100.

Returning to the unpolarised light arriving 254 at the transparent rear electrode 108. The light passes through the film 110 and through the quarter wave plate 112 and emerges 264 at the far side of the quarter wave plate as unpolarised light. The light is then reflected by a reflector 114 and travels through the quarter wave plate 112 to strike the fluorescent film 110.

The film 110 fluoresces due to the portion of the light striking it which is polarised in the plane of the page and emits light which is polarised in the plane of the page. This light is not absorbed by the guest dye molecules 104 as they are in their light state and emerges 268 from the front surface of the display 100 largely unattentuated.

The light 270 (which is unpolarised) striking the film 110 continues through the liquid crystal and is not absorbed by the guest dye molecules 104 as they are in their light state and the light emerges 272 from the front surface of the display 100.

Three components 262, 268, 272 of the exiting light have been described. In the light state of the liquid crystal display all three components pass through the liquid crystal largely unattenuated. The light 272 which was incident on the display forms the largest component of the exiting light, this component being increased by the fluorescence resulting from the light from the reflector causing the fluorescence component 268. The component 262 also increases the exiting light, but not to a great extent. Fluorescence always occurs at a longer wavelength than that of the radiation which exited the fluorescence, so ideally the fluorescent film 110 will absorb light from the near-ultra-violet portion of the electromagnetic spectrum and from the extreme blue of the visible light spectrum and then re-emit it at longer wavelengths, closer to the green portion of the visible light spectrum, where the eye is more sensitive. Therefore, although the total radiant energy reflected by the display will be less than in the absence of the fluorescent material, the total luminous intensity (that is the energy convoluted with the sensitivity function of the eye) will increase.

What is claimed:

1. A guest-host liquid crystal display comprising:
at least one compartment containing a guest-host liquid crystal;
a reflecting layer located adjacent to a surface of the at least one compartment;
a quarter wave plate located between the reflecting layer and the at least one compartment; and characterised in that the liquid crystal display further comprises:
a film containing an aligned layer of fluorescent material located between the at least one compartment and the quarter wave plate.

2. The guest host liquid crystal display of claim 1 further including a transparent rear electrode positioned between the at least one compartment and the film.

3. The guest host liquid crystal display of claim 2 further including a transparent front electrode positioned relative to the at least one compartment and displaced from said transparent front electrode positioned relative to the at least one compartment and displaced from said transparent rear electrode.

4. A display comprising:
a guest-host liquid crystal display comprising:
at least one compartment containing a guest-host liquid crystal;
a reflecting layer located adjacent to a surface of the at least one compartment;
a quarter wave plate located between the reflecting layer and the at least one compartment; and
characterised in that the liquid crystal display further comprises:
the quarter wave plate.

5. The display of claim 4 further including at least one electrode operatively placed relative to the at least one compartment.

6. The display of claim 5 wherein the at least one electrode is transparent.
